(19) United States
(12) Patent Application Publication
(10) Pub. No.: US 2017/0256991 A1
(43) Pub. Date: Sep. 7, 2017

(54) Cross-Connection Detection in Wireless Power Transmission Systems

(71) Applicant: WITRICITY CORPORATION, Watertown, MA (US)

(72) Inventors: Daniel Bronson, Nibley, UT (US); Kylee Devro Sealy, Logan, UT (US); Michael F. Lamenza, Belmont, MA (US)

(73) Assignee: WITRICITY CORPORATION, Watertown, MA (US)

(21) Appl. No.: 15/448,872

(22) Filed: Mar. 3, 2017

Related U.S. Application Data
(60) Provisional application No. 62/304,420, filed on Mar. 7, 2016.

(51) Int. Cl. H02J 50/12; H02J 50/80; H02J 50/90; H02J 7/02

(52) U.S. Cl. CPC H02J 50/12; H02J 7/025; H02J 50/80; H02J 50/90

(57) ABSTRACT

Methods and apparatus to detect a cross-connect situation in a wireless power transfer system having one or more power receiving units (PRUs) and one or more power transmitting units (PTUs). The PTU can perturb a transmit coil signal and look for expected correlation on wirelessly connected PRU to determine the presence of absence of a cross-connect condition.

### CROSS REFERENCE TO RELATED APPLICATIONS

The present application claims the benefit of U.S. Provisional Patent Application No. 62/304,420, filed on Mar. 7, 2016, which is incorporated herein by reference.

### SUMMARY

Wireless power transmission systems may rely on electronic circuits such as rectifiers, AC (Alternating Current) to DC (Direct Current) converters, impedance matching circuits, and other power electronics to condition, monitor, maintain, and/or modify the characteristics of the voltage and/or current used to provide power to electronic devices. Power electronics can provide power to a load with dynamic input impedance characteristics. In some cases, in order to enable efficient power transfer, a dynamic impedance matching network is provided to match varying load impedances to that of the power source.

In some applications, impedances within a wireless power system may vary dynamically. In such applications, for example, impedance matching between a load, such as a resonator coil, and a power supply of the apparatus may be required to prevent unnecessary energy losses and excess heat. Accordingly, power transfer systems transferring and/or receiving power via highly resonant wireless energy transfer, for example, may be required to configure or modify impedance matching networks to maintain efficient power transfer.

Embodiments provided herein describe methods and apparatus for detecting cross-connection in a wireless energy transfer system. Embodiments can include controlling current to a transmit coil of a power transmitter unit (PTU) to include perturbations having current level increases for selected durations of time and/or current level decreases for selected durations of time. The perturbed signal from the PTU can be received by a power receiving unit (PRU), which can transmit signal data derived from a receive coil of the PRU to the PTU. The PTU can be configured to interact with the PRU via an in-band wireless energy transfer channel and/or an out-of-band wireless communication channel. In embodiments, the data derived from the receive coil is transmitted by the PRU to the PTU via the out-of-band communication channel. The data received by the PTU can be processed to determine a level of correlation between the signal perturbations transmitted by the PTU transmit coil and the data from the PRU to determine a cross-connection, in other words, if the PRU is communicating with a PTU it is not coupled to for the purposes of wireless power reception. If so, the PRU can be disconnected from the unintended PTU. In embodiments, the disconnected PRU can be blacklisted by the PTU to prevent immediate reconnection that re-establishes a cross-connect condition.

In one aspect of the invention, a method comprises: transmitting first data from a power transmitter unit (PTU), via a first channel, by controlling a transmission parameter to a transmit coil of the PTU; receiving at the PTU, via a second channel, second data from a power receiving unit (PRU); and processing the received second data to determine a level of correlation between the first data and the second data to determine if the PRU is connected to the PTU.

The method can include one or more of the following features: controlling a transmission parameter comprises modulating the transmission parameter, the transmission parameter comprises a current, voltage, and/or power, modulating the transmission parameter includes increases and decreases of a level of the transmission parameter for selected durations of time, disconnecting the PRU from the PTU, blacklisting the disconnected PRU, the received data is indicative of rectified voltage of the PRU, the first channel is an in-band wireless power transfer channel, the second channel is an out-of-band wireless communication channel, the level of correlation is determined by calculating a derivative of the received data, an amplitude of the derivative is determined, a direction of the derivative is determined, and/or a timing of the derivative is determined.

In another aspect of the invention, a system comprises: a power transmitter unit (PTU) configured to transmit first data via a first channel by controlling a transmission parameter to a transmit coil of the PTU, and to receive via a second channel second data from a power receiving unit (PRU); and a processor module configured to process the received second data to determine a level of correlation between the first data and the second data to determine if the PRU is connected to the PTU.

The system can include one or more of the following features: modulating the transmission parameter, the transmission parameter comprises a current, voltage, and/or power, modulating the transmission parameter includes increases and decreases of a level of the transmission parameter for selected durations of time, disconnecting the PRU from the PTU, blacklisting the disconnected PRU, the received data is indicative of rectified voltage of the PRU, the first channel is an in-band wireless power transfer channel, the second channel is an out-of-band wireless communication channel, the level of correlation is determined by calculating a derivative of the received data, an amplitude of the derivative is determined, a direction of the derivative is determined, and/or a timing of the derivative is determined.

In a further aspect of the invention, a system comprises: a power transmitter unit (PTU) configured to transmit first data via a first channel, by controlling a transmission parameter to a transmit coil of the PTU, and to receive via a second channel, second data from a power receiving unit (PRU); and a means for cross-connect detection for processing the received second data to determine a level of correlation between the first data and the second data to determine if the PRU is connected to the PTU.

The system can further include one or more of the following features: controlling a transmission parameter comprises modulating the transmission parameter, the transmission parameter comprises a current, voltage, and/or power, modulating the transmission parameter includes increases and decreases of a level of the transmission parameter for selected durations of time, disconnecting the PRU from the PTU, blacklisting the disconnected PRU, the received data is indicative of rectified voltage of the PRU, the first channel is an in-band wireless power transfer channel, the second channel is an out-of-band wireless communication channel, the level of correlation is determined by calculating a derivative of the received data, an amplitude of the derivative is determined, a direction of the derivative is determined, and/or a timing of the derivative is determined.

### BRIEF DESCRIPTION OF THE DRAWINGS

FIG. 1 is a schematic representation of a wireless energy transfer system having cross-connect detection capability;

FIG. 2 is diagrammatic representation of power receiving units (PRUs) that may be located on or near power transmitting units (PTUs);

FIGS. 3A and 3B show example PTU-PRU cross-connect scenarios;

FIG. 4A is a signal diagram for signals than can be generated to detect cross detection;

FIG. 4B is a signal diagram that shows how signals may be processed to detect the absence of a cross-connection;

FIG. 4C is a signal diagram that shows how signals may be processed to detect the presence of a cross-connection;

FIG. 4D is a schematic representation that shows how a cross-connect detection process can be repeated to confirm a potential cross-connection;

FIG. 5 is a schematic representation that shows how a cross-connect detection process can be performed at time intervals;

FIG. 6 is a flow diagram showing an illustrative sequence of steps to detect cross-connection; and

FIG. 7 shows a schematic representation of an illustrative computer that can perform at least a portion of the processing described herein.

### DETAILED DESCRIPTION

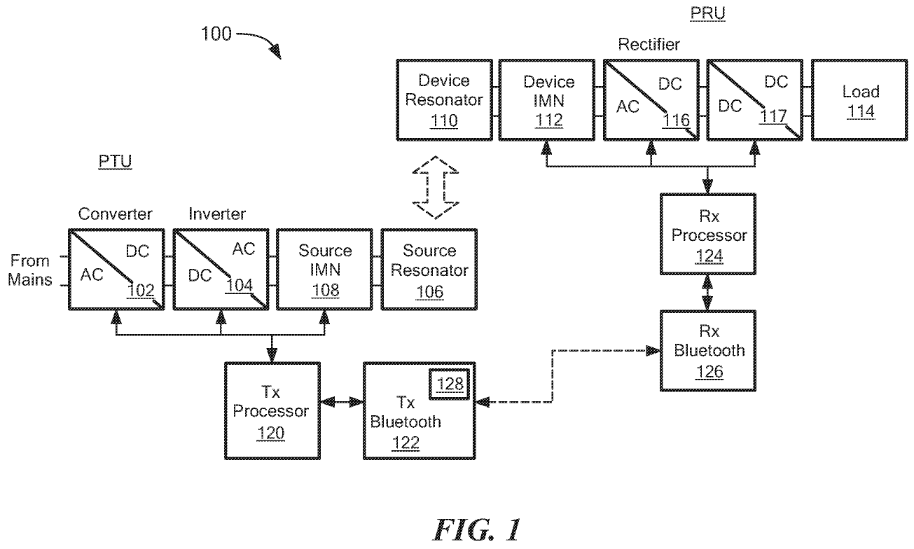

FIG. 1 shows a high level functional block diagram of an exemplary embodiment of a wireless power transfer system 100 having cross-connect detection capability. A power transmitting unit (PTU) can be considered a source that provides wireless energy to a power receiving unit (PRU), which can be provided as a device that can be coupled a load. Input power to the system can be provided by wall power (AC mains), for example, which is converted to DC in an AC/DC converter block 102. Alternatively, a DC voltage can be provided directly from a battery or other DC supply. In embodiments, the AC/DC converter block 102 may be a power factor correction (PFC) stage. The PFC, in addition to converting the AC input (for example, at 50 or 60 Hz) to DC, can condition the current such that the current is substantially in phase with the voltage. A high efficiency switching inverter or amplifier 104 converts the DC voltage into an AC voltage waveform used to drive a source resonator 106. In embodiments, the frequency of the AC voltage waveform may be in the range of 80 to 90 kHz. In embodiments, the frequency of the AC voltage waveform may be in the range of 10 kHz to 15 MHz. A source impedance matching network (IMN) 108 efficiently couples the inverter 104 output to the source resonator 106 and can enable efficient switching-amplifier operation. Class D or E switching amplifiers are suitable in many applications and can require an inductive load impedance for highest efficiency. The source IMN 108 transforms the source resonator impedance into such an impedance for the inverter 104. The source resonator impedance can be, for example, loaded by the coupling to a device resonator 110 and/or output load. The magnetic field generated by the source resonator 106 couples to the device resonator 110, thereby inducing a voltage. This energy is coupled out of the device resonator 110 to, for example, directly power a load 114, such as charging a battery. A device impedance matching network (IMN) 112 can be used to efficiently couple energy from the device resonator 110 to the load 114 and optimize power transfer between source resonator 106 and device resonator 110. It may transform the actual load impedance into an effective load impedance seen by the device resonator 110 which more closely matches the loading for optimum efficiency. For loads requiring a DC voltage, a rectifier 116 converts the received AC power into DC. A DC/DC converter 117 can regulate the voltage level for the load 114. In embodiments, the source 118 and device 120 can further include filters, sensors, and other components.

The impedance matching networks (IMNs) 108, 112 can be designed to maximize the power delivered to the load 114 at a desired frequency (e.g., 80-90 kHz, 100-200 kHz, 6.78 MHz) or to maximize power transfer efficiency. The impedance matching components in the IMNs 108, 112 can be chosen and connected so as to preserve a high-quality factor (Q) value of resonators 106, 110. Depending on the operating conditions, the components in the IMNs 108, 112 can be tuned to control the power delivered from the power supply to the load 114, for example, to maximize efficient wireless transmission of power.

The IMNs' (108, 112) components can include, for example, a capacitor or networks of capacitors, an inductor or networks of inductors, or various combinations of capacitors, inductors, diodes, switches, and resistors. The components of the IMNs can be adjustable and/or variable and can be controlled to affect the efficiency and operating point of the system. Impedance matching can be performed by varying capacitance, varying inductance, controlling the connection point of the resonator, adjusting the permeability of a magnetic material, controlling a bias field, adjusting the frequency of excitation, and the like. The impedance matching can use or include any number or combination of varactors, varactor arrays, switched elements, capacitor banks, switched and tunable elements, reverse bias diodes, air gap capacitors, compression capacitors, barium zirconium titanate (BZT) electrically tuned capacitors, microelectromechanical systems (MEMS)-tunable capacitors, voltage variable dielectrics, transformer coupled tuning circuits, and the like. The variable components can be mechanically tuned, thermally tuned, electrically tuned, piezo-electrically tuned, and the like. Elements of the impedance matching can be silicon devices, gallium nitride devices, silicon carbide devices, and the like. The elements can be chosen to withstand high currents, high voltages, high powers, or any combination of current, voltage, and power. The elements can be chosen to be high-Q elements.

The IMNs 108, 112 and/or control circuitry monitors impedance differences between the source 118 and the device 120 and provides control signals to tune the IMNs 108, 112 or components thereof. In some implementations, the IMNs 108, 112 can include a fixed IMN and a dynamic IMN. For example, a fixed IMN may provide impedance matching between portions of the system with static impedances or to grossly tune a circuit to a known dynamic impedance range.

In some implementations, a dynamic IMN can be further composed of a coarsely adjustable components and/or a finely adjustable components. For example, the coarsely adjustable components can permit coarse impedance adjustments within a dynamic impedance range whereas the finely adjustable components can be used to fine tune the overall impedance of the IMN(s). In another example, the coarsely adjustable components can attain impedance matching within a desirable impedance range and the finely adjustable components can achieve a more precise impedance around a target within the desirable impedance range.

It is understood that the source and/or device impedance matching networks (IMNs) can have a wide range of circuit implementations with various components having impedances to meet the needs of a particular application. U.S. Pat. No. 8,461,719 to Kesler et al. and U.S. Pat. No. 8,922,066 to Kesler et al., which are incorporated herein by reference, disclose a variety of tunable impedance networks, such as in FIGS. 28a-37b, for example.

In embodiments, the PTU/source can include a processor module 120 to control overall operation of the source side components and a wireless communication module 122 coupled to the processor 120 to provide wireless communication to other units. It is understood that any suitable wireless communication technology can be used, such as Bluetooth®, BLE (Bluetooth® Low Energy), WiFi, radio, and the like. In embodiments, the processor module 120 can include a correlation module to correlate PTU and PRU signals, as described more fully below.

The PRU/device can include a processor module 124 to control the overall operation of the device components and a wireless communication module 126 to enable the PRU to communicate with PTU and/or PRU units.

In embodiments, the PTU includes a cross-connect detection module 128 that can detect PTU-PRU cross-connection, as described more fully below. While the cross-connect detection module 128 is shown as part of the wireless connection module 122 on the PTU, it is understood that the cross-connection module can reside in any suitable location with access to wireless communication and access to the mechanisms which control the current in the PTU transmitting coil. This may include impedance change information, voltage signals, current signals, PWM signals, and other signals transmitted by the source resonator 106, as described more fully below. For example, the cross-connect detection module 128 can form part of the PTU processor module 120.

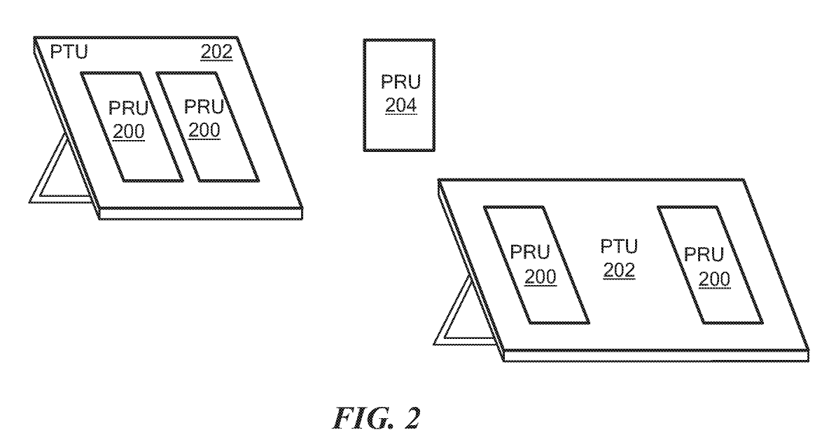

FIG. 2 shows various PRUs 200 on charging platforms of PTUs 202, as well a nearby PRU 204. In embodiments, a power transmitting unit (PTU) interacts with a power receiving unit (PRU) via an in-band channel and an out-of-band channel. As used herein, in-band refers to power transmission channel between the PTU 202 and PRU 200. As described more fully below, the PTU 200 can modulate the transmitted wireless energy to communicate with the PRU 202 and the PRU can modify certain characteristics, such as impedance, to communicate with the PTU. As used herein, out-of-band refers to wireless communication between a PTU 202 and PRU 200 via a wireless protocol, such as Bluetooth®. It is understood that any suitable wireless communication technology, protocol, etc., can be used to enable PTUs and PRUs to communicate with each other. As described more fully below, in-band and out-of-band communication can be established in an unknown state in which a first PRU is connected to a first PTU via an in-band channel and is connected to a second PTU via an out-of-band channel resulting in PTU-PRU cross-connection. It is understood that the terms in-band and out-of-band are used for convenience and should not be used to limit the claimed invention in any way.

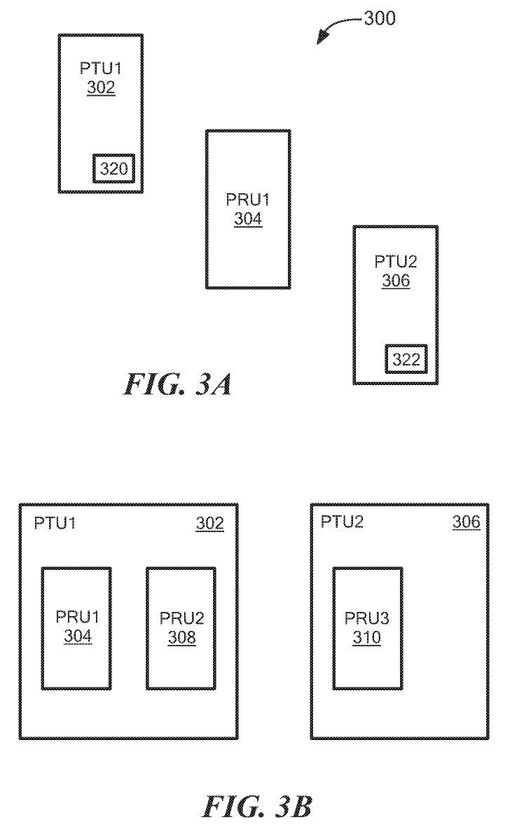

FIG. 3A shows a wireless power transmission system 300 having cross-connection detection capability. As used herein, cross-connection refers to a first power transmitting unit (PTU) 302 charging a power receiving unit (PRU) 304, which is in communication with a second power transmitting unit (PTU) 306 via a wireless communication protocol, such as Bluetooth®. The first PTU 302 includes a cross-detection module 320 and the second PTU 306 can also include a cross-detection module 322.

FIG. 3B shows a further illustration of cross-connection detection for first and second PTUs 302, 306 and first, second, and third PRUs 304, 308, 310. In one scenario, the first PTU 302 is charging the first and second PRUs 304, 308. However the first PTU 302 is only ‘aware’ that it is charging the first PRU 304 since the first PTU 302 is only communicating out-of-band, e.g., Bluetooth®, with the first PRU 304.

In another scenario, the second PTU 306 is charging (in-band) the third PRU 310 while communicating with the second and third PRUs 308, 310. In this scenario, the second PTU 306 ‘believes’ that it is charging the second and third PTUs 308, 310. In general, when the in-band and out-of-band communication channels are not consistent with each other with respect to PTU and PRU, a cross-connection may be present.

In embodiments, a beacon-advertisement protocol is used to establish in-band and out-of band communication between PTUs and PRUs. A PTU can transmit beacon signals from a resonator coil that ‘look’ for nearby PRUs, e.g., a device placed on a charging pad, by detecting impedance changes due to the nearby PRU. In response, a PRU can transmit advertisement messages via wireless communication, e.g., Bluetooth®, that can include impedance change information. The PTU accepts the PRU communication request, for example, if the signal strength is above a threshold, which can be set to a level corresponding to a PRU within some given distance from the PTU. In embodiments, the PTU connects to a PRU if the PTU detects the PRU by an impedance shift and the signal strength threshold for the advertisement messages is met. In embodiments, if only one condition (impedance shift or signal strength) is met, the PTU must still issue a connection request to the PRU under certain conditions. It is understood that this arrangement may favor establishing a connection over not establishing a connection to a desired level. If a PRU has a relatively high signal strength level, a PTU may establish an out-of-band connection to the PRU, which is charged (in-band) by a different PTU or nearby PRU. In embodiments, a first PRU may be charged by a second PRU. In addition, a false impedance shift detection may result in a cross-connection situation if PRU advertisement messages are received by a PTU. Also, a connection may be required by a standard or protocol if a PRU advertisement is received a certain number of times in a given time period.

In one particular embodiment, a beacon-advertisement protocol for PTU-PRU communication is set forth in Airfuel (formerly A4WP) Wireless Power Transfer System Baseline System Specification (BSS) v1.2.1, approved May 7, 2014, which is incorporated herein by references.

It is understood that cross-connects can occur due to a wide range of parameters and protocol directives which do not limit the scope of the invention in any way.

In embodiments of the invention, PTU-PRU cross-detection can be detected by perturbing a transmit coil of a PTU and evaluating the response of the PRU coil. For example, a current level increase on the PTU transmit coil should cause a corresponding voltage increase on the receive coil of a connected PRU, and vice-versa. If the current change is not tracked by an out-of-band connected PRU, then the PRU is likely not being charged by that PTU.

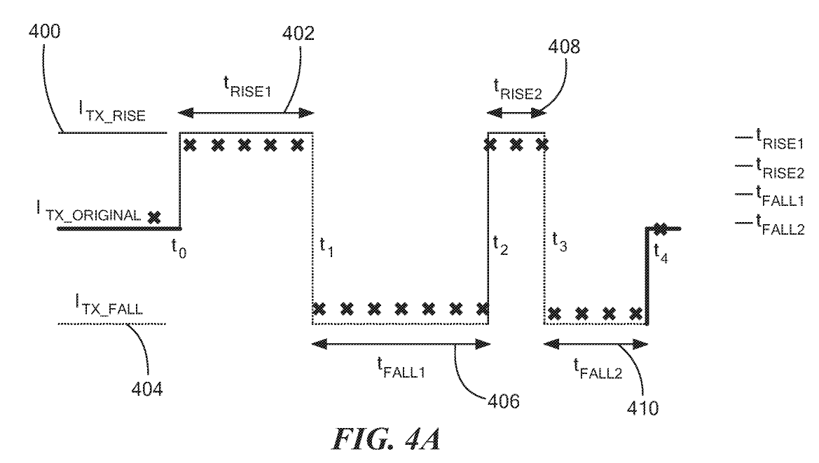

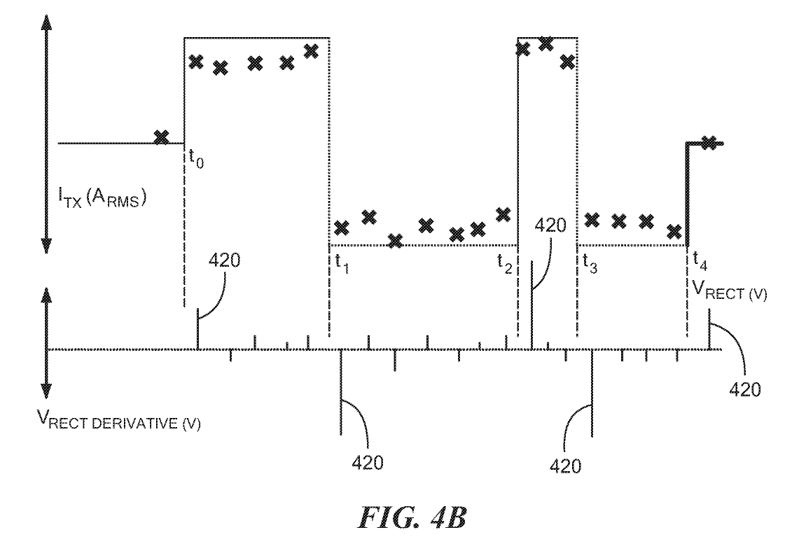

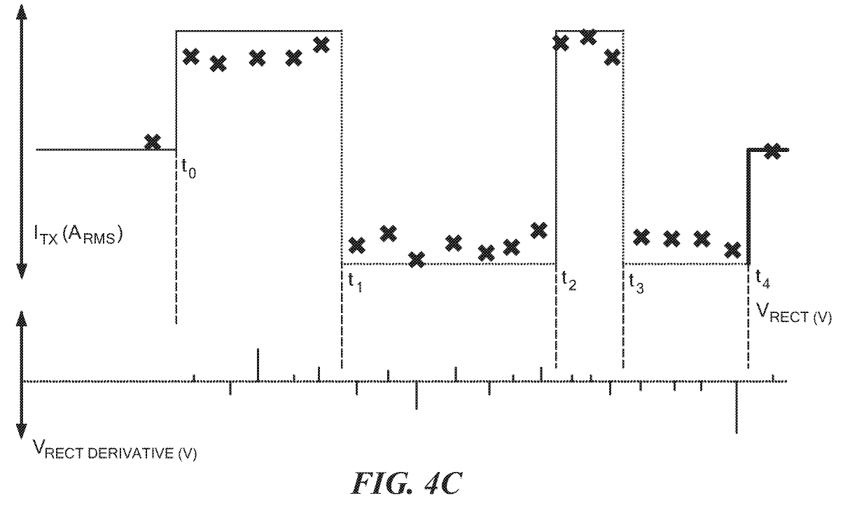

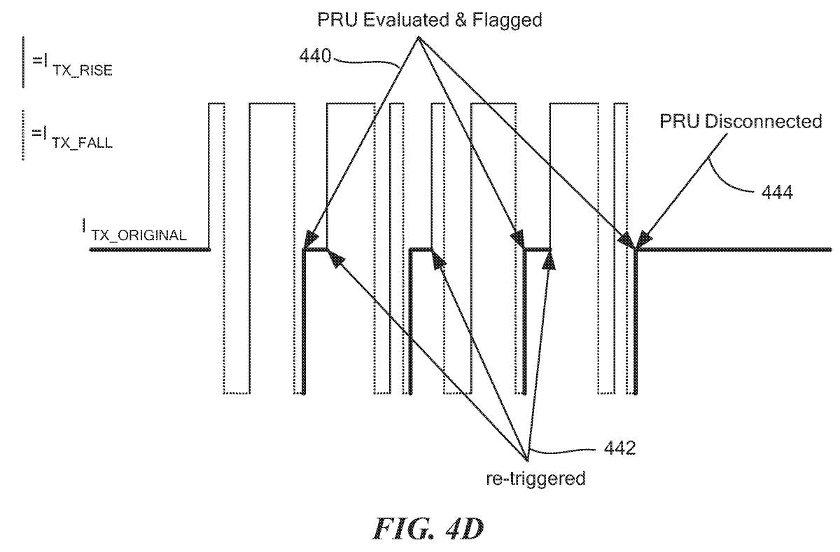

FIG. 4A shows illustrative signaling after in-band and out-of-band communication is established to detect cross-connection in accordance with embodiments of the invention. Before time t0, the PTU energizes the transmit coil with a current I_{TX}_{_}_{ORIGINAL}. At time t0, the PTU perturbs the coil current by increasing or decreasing the current level. In embodiments, the coil current transitions can occur at random times and/or for random durations. In embodiments, instead of a ‘random time’, a random number of ‘reported samples’ from the PRU can be determined and used for a similar purpose. For example, referring to the FIG. 4A, instead of measuring random time tRISE1, the PTU can wait for a random number of samples tNUMSAMPLESRISE1 to be accumulated from the PRU before moving to the next transition.

In the illustrated embodiment, the coil current rises at time t0 to I_{TX}_{_}_{RISE} 400 and remains there for a random amount of time t_{RISE1} 402, which expires at time t1 at which the coil current falls to I_{TX}_{_}_{FALL} 404 for a further random amount of time t_{FALL1} 406. When this time expires, the coil current rises to I_{TX}_{_}_{RISE} 400 and remains there for another random amount of time t_{RISE2} 408. At time t3, at which time t_{RISE2} 408 expires, the coil current level falls to I_{TX}_{_}_{FALL} 404 for time t_{FALL2} 410 which expires at time t4. The coil current can go to a desired level after cross-connect detection signaling.

In embodiments, any suitable random number generating process can be used to generate current transition times and/or time durations. In embodiments, a pseudo random number generator is used to generate the random time durations or samples of the rise and fall current levels described above. In one particular embodiment, a random number generator is seeded with a unique identifier of a hardware component in the PTU, such as an IC on a wireless communication module (see, e.g., 122 FIG. 1).

It is understood that the PTU coil current level can be the same or different after each rise and each fall. In embodiments, the coil current rise and fall times are of sufficient duration to capture at least three PRU V_{RECT} reports. In the illustrated embodiment, an ‘X’ above or below the current level indicates illustrative PRU rectifier voltage V_{RECT} reports to the PTU. The V_{RECT} reports can be accepted/stored/saved after sufficient signal setting time.

If the out-of-band connected PRU is not cross-connected, the PTU coil current perturbation will cause corresponding reactions at the output of the PRU rectifier. In embodiments, the PRU sends a rectifier value V_{RECT} to the PTU for processing to determine whether the PTU coil perturbations affected the PRU receive coil in manner expected for an in-band connected PRU. That is, if there is no cross-connection, the PRU will ‘see’ the PTU coil current perturbations and transmit rectifier values V_{RECT} that are consistent with an in-band connected PRU.

A cross-connection module on the PTU (320, FIG. 3) can process the rectifier values V_{RECT} to determine whether there is correlation with the PTU coil current rise and fall times. In embodiments, the current direction, i.e., rise or fall, can also be evaluated for consistency with the PTU coil current changes. If the rectifier values V_{RECT} do not correlate with the timing and direction of the coil current perturbations, the PRU is flagged as potentially cross-connected to the out-of-band connected PTU. In embodiments, the PTU coil current perturbation process can be repeated a desired number of times for cross-connection and/or non-cross-connection.

FIG. 4B shows a PTU coil current signal time-aligned with PRU rectifier values V_{RECT} received by the PTU. In the illustrated embodiment, a derivative is taken of the received PRU rectifier values V_{RECT} to determine whether there is correlation in time and direction with the PTU coil current signal. As can be seen, at times t0, t1, t2, t3, t4, there is alignment (subject to propagation and processing delays) of the PTU coil current direction and duration with the derivative rectifier values V_{RECT} 420. Thus, it appears that there is no cross-detection, i.e., the PTU and PRU are connected to each other by in-band and out-of-band channels. For example, a PRU on a charging surface of a PTU will generally not be subject to a cross connection. However, where a number of PTUs are relatively close to each other with PRUs on or near PTU charging surfaces the likelihood of cross-connects increases.

FIG. 4C shows PTU coil current signal time-aligned with PRU rectifier values V_{RECT} received by the PTU for a potential cross-connect situation. As can be seen, there is little correlation between the PTU coil current signal and the PRU rectifier values V_{RECT} received by the PTU. Thus, the PRU may be flagged by the PTU as potentially cross-connected. In order for a PRU to not be considered a potential cross-connect, the PTU expects the PRU V_{RECT} to track the PTU coil current in both time and direction. If the largest magnitudes of the V_{RECT}_{_}_{DERIVATIVE} do not align in time and direction of the coil current perturbation, the PRU is considered a potential source of cross-connect.

It is understood that the parameters for detecting the presence or absence of a cross connect can be varied to meet the needs of a particular application and disconnection policy. That is, it may be very undesirable in certain applications to disconnect PRUs. In other applications, it may be desirable to disconnect PRUs that are cross-connected to the extent possible.

FIG. 4D shows illustrative cross-connect processing and PRU disconnection. In the illustrated embodiment, the PTU coil current is perturbed by rising and falling current levels at random time durations. Once a PRU is flagged 440 as potentially cross-connected with the PTU, as shown in FIG. 4C, the coil current signaling is repeated for a selected number of times (shown as three after PRU is flagged). In embodiments, each repeat of the PTU coil current perturbations has current rise and fall levels with random time durations.

If the PRU is determined to be cross-connected, the PTU can disconnect 444 the PRU. In embodiments, the disconnected PRU can be placed on a so-called blacklist, for some period of time, to prevent the cross-connection from occurring again. The parameters for placement on a blacklist can be selected to meet the needs of a particular application. For example, a blacklist time can correspond to an expected number of PTUs in range of each other (capable of cross-connecting) and an amount of time to detect and address a cross-connection. It is understood that, in general, a disconnected/blacklisted PRU may readily connect with a different PTU.

In embodiments, the PRU has a unique identifier that can be used to identify the PRU for the blacklist. It is understood that any practical identifier for the PRU can be used to meet the needs of a particular application.

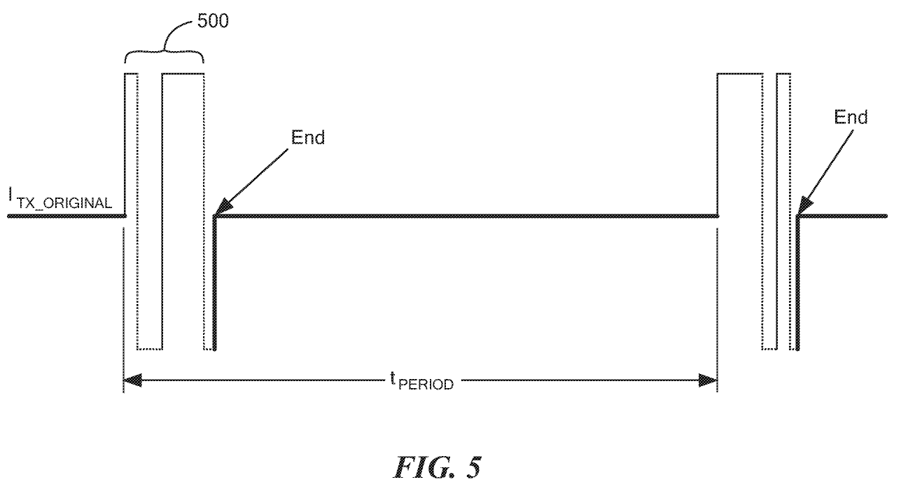

As shown in FIG. 5, cross-connect processing 500 can occur at times selected to meet the needs of a particular application. For example, in the illustrated embodiment, cross-connection detection can be initiated in a desired manner. In embodiments, cross-connect processing 500 can be initiated at random times with a minimum time between processes and a maximum time between processes. In addition, cross-connection processing can be increased during certain conditions, such as relatively high density of nearby PTUs and/or PRUs. As discussed above, if a potential cross-connect situation is detected, processing can be repeated to confirm the cross-connection.

Illustrative parameters, descriptions, and values are set forth in respective columns in Table 1 below. It is understood that only some of the listed variables may be used and that additional variables may be used in other cross-detection processing. It is further understood that the values listed are illustrative and can readily vary to meet the needs of a particular application as will be readily apparent to one of ordinary skill in the art.

TABLE 1

| | | |
|---|---|---|
| I_{TX}_{_{—}}_{RISE} | The amount of RMS | 5% of I_{TX}_{_{—}}ₘₐₓ |
| | current the I_{TX}_{_{—}}_{COIL} is | (10 relative value) |
| | raised by cross-connect | |
| | detection processing | |
| I_{TX}_{_{—}}_{FALL} | The amount of RMS | 5% of I_{TX}_{_{—}}ₘₐₓ |
| | current the I_{TX}_{_{—}}_{COIL} is | (10 relative value) |
| | lowered by cross-connect | |
| | detection processing | |
| MIN_RANDOM_STATE_DURATION | The minimum amount of | 770 ms (enough for at |
| | time that the cross-connect | least 3 PRU reports) |
| | detection processing | |
| | must persist in a state. | |
| MAX_RANDOM_STATE_DURATION | The maximum amount of | 1800 ms (up to at |
| | time that the cross-connect | least 7 PRU reports) |
| | detection processing | |
| | may persist in a state. | |
| MIN_RANDOM_INACTIVE_DURATION | The minimum amount of | 3000 ms |
| | time that the detection | |
| | processing may be inactive | |
| | before being run again. | |
| MAX_RANDOM_INACTIVE_DURATION | The maximum amount of | 30000 ms |
| | time that the cross-connect | |
| | detection processing may | |
| | be inactive before | |
| | being run again. | |
| PRU_FLAG_CROSS_CONNECT_TIMES | The number of times that | 3 |
| | a PRU is flagged as | |
| | ‘potentially’ cross-connected | |
| | before it is considered | |
| | ‘officially’ cross-connected. | |

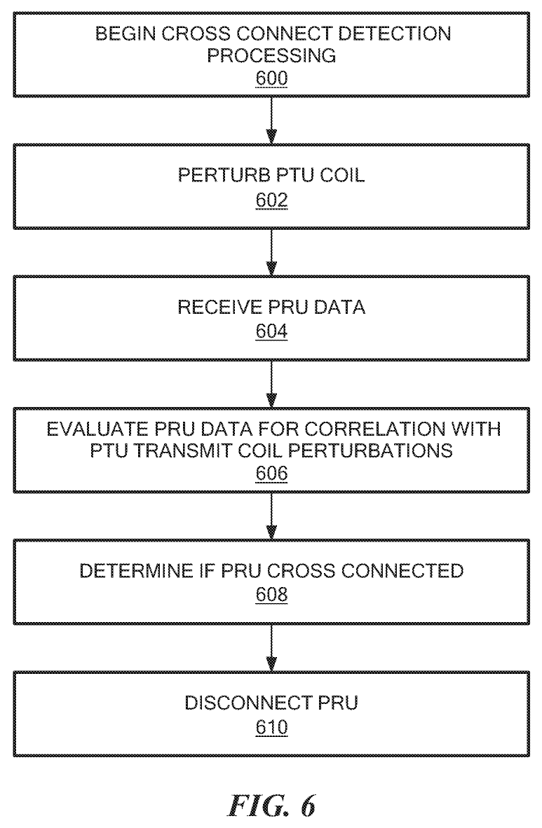

FIG. 6 shows an illustrative sequence of steps for providing cross-connect detection in a wireless energy transfer system in accordance with illustrative embodiments of the invention. In step 600, cross connection processing is initiated by a PTU. In step 602, the current of the PTU transmit coil is perturbed by increasing and decreasing the current level. In embodiments, the current levels are maintained for random amounts of time. In step 604, a PRU that is connected via an out-of-band channel, such as through BLE, transmits data derived from a rectifier coil of the PRU, for example. In general, the data for the PRU can be derived from any component that will react to the signal perturbations from the PTU and sent to the PTU. In step 606, the PTU evaluates the PRU data for correlation with the PTU transmit coil perturbations. In step 608, the PTU determines whether the PRU should be flagged as potentially cross connected with a different PTU. In embodiments, the cross connect detection processing can be repeated a desired number of times to arrive at a determination as to whether the PRU is cross-connected. In step 610, a PRU that has been determined to be cross connected with the PTU is disconnected. The PTU can be blacklisted for a period of time to prevent re-occurrence of the cross connection situation.

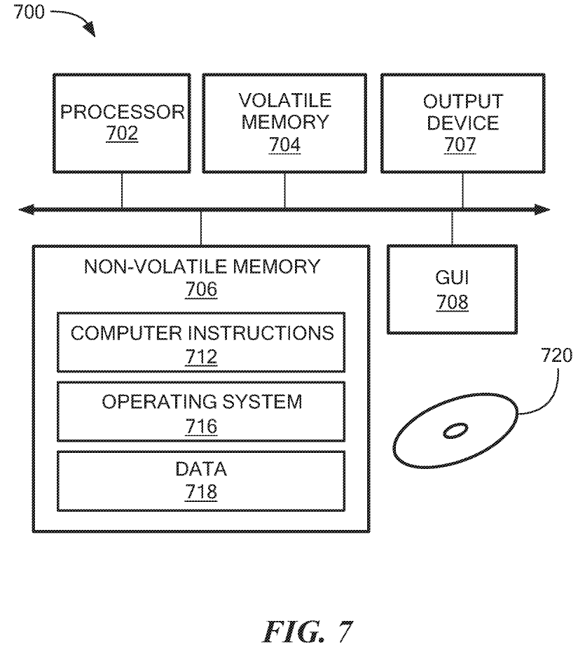

FIG. 7 shows an exemplary computer 700 that can perform at least part of the processing described herein. The computer 700 includes a processor 702, a volatile memory 704, a non-volatile memory 706 (e.g., hard disk), an output device 707 and a graphical user interface (GUI) 708 (e.g., a mouse, a keyboard, a display, for example). The non-volatile memory 706 stores computer instructions 712, an operating system 716 and data 718. In one example, the computer instructions 712 are executed by the processor 702 out of volatile memory 704. In one embodiment, an article 720 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer.

Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A method comprising:
transmitting first data from a power transmitter unit (PTU), via a first channel, by controlling a transmission parameter to a transmit coil of the PTU;
receiving at the PTU, via a second channel, second data from a power receiving unit (PRU); and
processing the received second data to determine a level of correlation between the first data and the second data to determine if the PRU is connected to the PTU.

2. The method of claim 1 wherein the controlling a transmission parameter comprises modulating the transmission parameter.

3. The method of claim 1 wherein the transmission parameter comprises a current, voltage, and/or power.

4. The method of claim 2 wherein the modulating the transmission parameter includes increases and decreases of a level of the transmission parameter for selected durations of time.

5. The method of claim 1 further including disconnecting the PRU from the PTU.

6. The method of claim 5 further including blacklisting the disconnected PRU.

7. The method of claim 1 wherein the received data is indicative of rectified voltage of the PRU.

8. The method of claim 1 wherein the first channel is an in-band wireless power transfer channel.

9. The method of claim 1 wherein the second channel is an out-of-band wireless communication channel.

10. The method of claim 1 wherein the level of correlation is determined by calculating a derivative of the received data.

11. The method of claim 10 wherein an amplitude of the derivative is determined.

12. The method of claim 10 wherein a direction of the derivative is determined.

13. The method of claim 10 wherein a timing of the derivative is determined.

14. A system, comprising:
a power transmitter unit (PTU) configured to transmit first data via a first channel by controlling a transmission parameter to a transmit coil of the PTU, and to receive via a second channel second data from a power receiving unit (PRU); and
a processor module configured to process the received second data to determine a level of correlation between the first data and the second data to determine if the PRU is connected to the PTU.

15. The system of claim 14 wherein the transmission parameter includes increases and decreases of a level of the transmission parameter for selected durations of time.

16. The system of claim 14 wherein the level of correlation is determined by calculating a derivative of the received data.

17. The system of claim 16 wherein an amplitude of the derivative is determined, wherein a direction of the derivative is determined, and/or a timing of the derivative is determined.

18. A system comprising:
a power transmitter unit (PTU) configured to transmit first data via a first channel, by controlling a transmission parameter to a transmit coil of the PTU, and to receive via a second channel, second data from a power receiving unit (PRU); and
a means for cross-connect detection for processing the received second data to determine a level of correlation between the first data and the second data to determine if the PRU is connected to the PTU.

19. The system of claim 18 wherein the transmission parameter includes increases and decreases of a level of the transmission parameter for selected durations of time.

20. The system of claim 18 wherein the level of correlation is determined by calculating a derivative of the received data.

21. The system of claim 18 wherein an amplitude of the derivative is determined, wherein a direction of the derivative is determined, and/or a timing of the derivative is determined.
